(19) United States
(12) Patent Application Publication
(10) Pub. No.: US 2006/0244713 A1
(43) Pub. Date: Nov. 2, 2006

(54) Electrophoretic display panel

(75) Inventors: Guofu Zhou, Eindhoven (NL); Masaru Yasui, Kobe (JP); Mark Thomas Johnson, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V., Eindhoven (NL)

(21) Appl. No.: 10/558,735

(22) PCT Filed: May 19, 2004
(86) PCT No.: PCT/IB04/50748

§ 371 Date: Nov. 29, 2005

(30) Foreign Application Priority Data
Jun. 2, 2003 (EP) 03101588.6

(51) Int. Cl. G09G 3/34

(52) U.S. Cl. 345/107

(57) ABSTRACT

The electrophoretic display panel (1) for displaying a picture has a plurality of pixels (2) and drive means (100). Each pixel (2) has two electrodes (3, 4) for receiving a potential difference and charged particles (6) capable of occupying a number of different positions between the electrodes (3, 4). The drive means (100) are able to supply a sequence of potential difference pulses to each pixel (2), each sequence having, to display the picture, a picture pulse for bringing the particles (6) into one of the positions. For the display panel (1) to be able to display a picture of at least relatively medium quality even shortly after the application of the sequences, with respect to at least a number of the pixels (2) having received picture pulses for bringing their particles (6) into extreme positions, the sequence of each pixel (2) out of said number has an additional picture pulse subsequent to the picture pulse, which additional picture pulse serves to prevent the particles (6) from substantially changing their position.

The invention relates to an electrophoretic display panel for displaying a picture comprising
a plurality of pixels, each pixel comprising two electrodes for receiving a potential difference and charged particles capable of occupying a number of different positions between the electrodes, and
drive means for supplying a sequence of potential difference pulses to each pixel, each sequence comprising, to display the picture, a picture pulse for bringing the particles into one of the positions.

Electrophoretic display panels in general are based on the motion of charged, usually colored particles under the influence of an electric field between electrodes. With these display panels, dark (colored) characters can be imaged on a light (colored) background, and vice versa. Electrophoretic display panels are therefore notably used in display devices taking over the function of paper, referred to as “white paper” applications (electronic newspapers, electronic diaries). The pixels have, during the display of the picture, appearances determined by the positions of the charged particles between the electrodes. The sequences of potential difference pulses consist of picture pulses for bringing the particles into the positions for displaying the picture. However, the appearances of pixels have changed substantially after a period of time of about one second after the application of the sequences. Therefore, the picture being displayed immediately after the application of the sequences has a relatively high quality compared to the relatively low quality of the picture being displayed after a period of time of about one second after the application of the sequences.

It is a drawback of the display panels in general that the quality of the picture being displayed shortly after the application of the sequences is relatively low.

It is an object of the invention to provide a display panel of the kind mentioned in the opening paragraph which is able to display a picture of at least relatively medium quality even shortly after the application of the sequences.

The object is thereby achieved that with respect to at least a number of the pixels having received picture pulses for bringing their particles into extreme positions, the sequence of each pixel out of said number comprises an additional picture pulse subsequent to the picture pulse, which additional picture pulse serves to prevent the particles from substantially changing their position.

The particles being in one of the extreme positions as a result of the picture pulses substantially remain in their position as a result of the additional picture pulses. Therefore, the appearances of the pixels out of said number are substantially unchanged and the picture being displayed is of at least relatively medium quality shortly after the application of the sequences. This is in contrast to the display panels in general, where the particles being in the extreme positions as a result of the picture pulses substantially change their position shortly after the application of the picture pulses, i.e. the particles undergo a sort of kick back from their extreme position. Therefore, the quality of the picture being displayed by the display panels in general, shortly after the application of the picture pulses, is relatively low. An explanation of the kick back effect might be that the particles behave as hard balls which hit on the electrodes as a result of the picture pulses and come off the electrodes after the application of the picture pulses.

In an embodiment
each picture pulse has a picture value and an associated picture duration together representing a picture energy,
each additional picture pulse has an additional picture value and an associated additional picture duration representing an additional picture energy,
the additional picture value has a sign equal to a sign of the picture value,
the additional picture value has a magnitude smaller than a magnitude of the picture value, and
the additional picture energy is smaller than the picture energy.

The additional picture energy supplied to each pixel out of said number may be controlled by controlling both the additional picture value and the associated additional picture duration.

It is favorable, if the magnitude of each additional picture value is smaller than half the magnitude of the picture value. Then the frame period may have a standard length of about 20 msec. Preferably, each additional picture energy is smaller than half the picture energy. Then the build up of excessive DC components is reduced.

It is favorable, if each interval between the picture pulse and the additional picture pulse is substantially zero. Then the image update time is reduced.

In another embodiment
each picture pulse has a picture value and an associated picture duration together representing a picture energy,
each additional picture pulse has a predetermined number of sub-additional picture values and associated sub-additional picture durations representing sub-additional picture energies,
a time average of the sub-additional picture values has a sign equal to a sign of the picture value, and
each sub-additional picture energy is smaller than the picture energy. Then the number of the sub-additional picture values can be chosen to optimize the optical response of the pixel. If, furthermore, each sub-additional picture value has a sign equal to the sign of the picture value, the application of each sub-additional picture value has the effect of at least partly preventing the particles from changing their position.

It is favorable, if, in each aforementioned embodiment, said number of the pixels is equal to the total number of the pixels having received picture pulses for bringing their particles into extreme positions.

In an embodiment the display panel is part of a display device.

In accordance with the present invention, there is provided a method for driving an electrophoretic display panel for displaying a picture, said display panel comprising a plurality of pixels, each pixel comprising two electrodes for receiving a potential difference and charged particles capable of occupying a number of different positions between the electrodes, said method comprising the step of supplying a sequence of potential difference pulses to each pixel, each sequence comprising, to display the picture, a picture pulse for bringing the particles into one of the positions, wherein, with respect to at least a number of the pixels having received picture pulses for bringing their particles into extreme positions, the sequence of each pixel out of said number comprises an additional picture pulse subsequent to the picture pulse, which additional picture pulse serves to prevent the particles from substantially changing their position.

Also in accordance with the present invention, there is provided drive means for driving an electrophoretic display panel for displaying a picture, said display panel comprising a plurality of pixels, each pixel comprising two electrodes for receiving a potential difference and charged particles capable of occupying a number of different positions between the electrodes, said drive means being arranged to supply a sequence of potential difference pulses to each pixel, each sequence comprising, to display the picture, a picture pulse for bringing the particles into one of the positions, wherein, with respect to at least a number of the pixels having received picture pulses for bringing their particles into extreme positions, the sequence of each pixel out of said number comprises an additional picture pulse subsequent to the picture pulse, which additional picture pulse serves to prevent the particles from substantially changing their position.

Although the invention has been described for a display panel comprising a plurality of pixels, it is clear for the man skilled in the art that the invention can also be used for a display panel comprising a single pixel, for instance in signage applications.

These and other aspects of the display panel of the invention will be additional elucidated and described with reference to the drawings, in which:

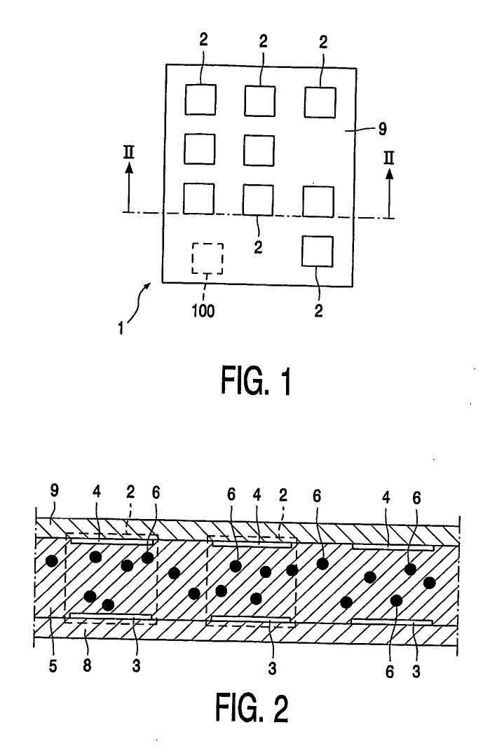

FIG. 1 shows diagrammatically a front view of an embodiment of the display panel;

FIG. 2 shows diagrammatically a cross-sectional view along II-II in FIG. 1;

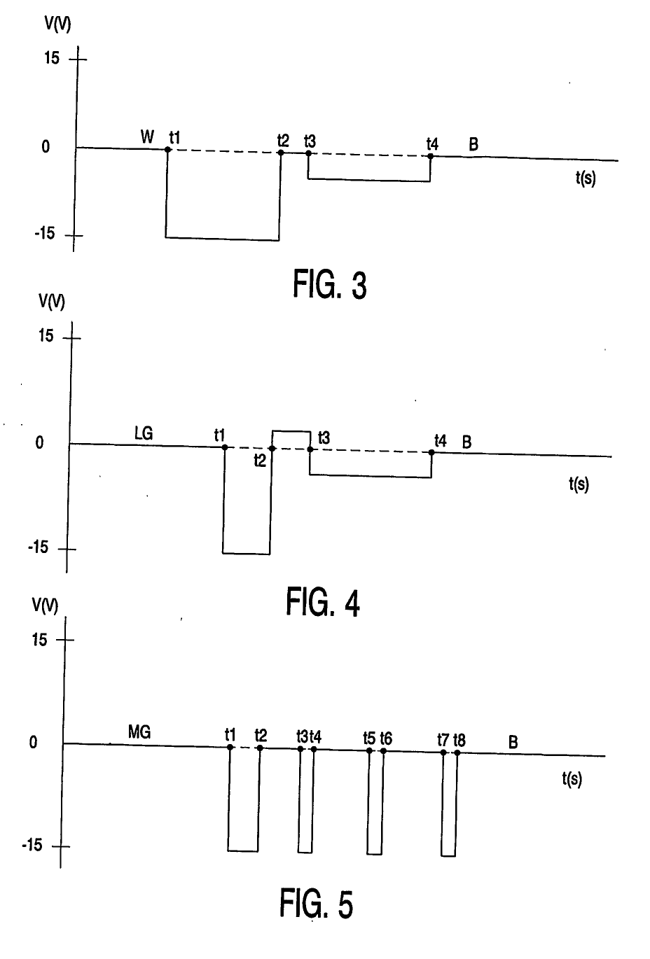

FIG. 3 shows diagrammatically the sequence of potential difference pulses as a function of time for a pixel out of said number of pixels in the embodiment;

FIG. 4 shows diagrammatically the sequence of potential difference pulses as a function of time for a pixel out of said number of pixels in another embodiment, and

FIG. 5 shows diagrammatically the sequence of potential difference pulses as a function of time for a pixel out of said number of pixels in another embodiment.

In all the Figures corresponding parts are referenced to by the same reference numerals.

FIGS. 1 and 2 show an example of the display panel 1 having a first substrate 8, a second transparent opposed substrate 9 and a plurality of pixels 2. Preferably, the pixels 2 are arranged along substantially straight lines in a two-dimensional structure. Other arrangements of the pixels 2 are alternatively possible, e.g. a honeycomb arrangement. An electrophoretic medium 5, having charged particles 6 in a fluid, is present between the substrates 8,9. A first and a second electrode 3,4 are associated with each pixel 2 for receiving a potential difference. In FIG. 2 the first substrate 8 has for each pixel 2 a first electrode 3, and the second substrate 9 has for each pixel 2 a second electrode 4. The charged particles 6 are able to occupy a position being one of extreme positions near the electrodes 3,4 and intermediate positions in between the electrodes 3,4. Each pixel 2 has an appearance determined by the position of the charged particles 6 between the electrodes 3,4. Electrophoretic media 5 are known per se from e.g. U.S. Pat. No. 5,961,804, U.S. Pat. No. 6,120,839 and U.S. Pat. No. 6,130,774 and can e.g. be obtained from E Ink Corporation. As an example, the electrophoretic medium 5 comprises negatively charged black particles 6 in a white fluid. When the charged particles 6 are in a first extreme position, i.e. near the first electrode 3, as a result of the potential difference being e.g. 15 Volts, the appearance of the pixel 2 is e.g. white. Here it is considered that the pixel 2 is observed from the side of the second substrate 9. When the charged particles 6 are in a second extreme position, i.e. near the second electrode 4, as a result of the potential difference being of opposite polarity, i.e. −15 Volts, the appearance of the pixel 2 is black. When the charged particles 6 are in one of the intermediate positions, i.e. in between the electrodes 3,4, the pixel 2 has one of the intermediate appearances, e.g. light gray, middle gray and dark gray, which are gray levels between white and black. The drive means 100 are able to supply a sequence of potential difference pulses to each pixel 2, each sequence comprising a picture pulse for bringing the particles 6 into one of the positions for displaying the picture. With respect to at least a number of the pixels 2 having received picture pulses for bringing their particles 6 into extreme positions, the sequence of each pixel 2 out of said number comprises an additional picture pulse subsequent to the picture pulse, which additional picture pulse serves to prevent the particles 6 from substantially changing their position.

In an embodiment each picture pulse has a picture value and an associated picture duration together representing a picture energy. Furthermore, each additional picture pulse has an additional picture value and an associated additional picture duration representing an additional picture energy. A sign of the additional picture value is equal to a sign of the picture value, a magnitude of the additional picture value is smaller than a magnitude of the picture value, and the additional picture energy is smaller than the picture energy. In an example, the sequence of potential difference pulses of a pixel 2 out of said number is shown as a function of time in FIG. 3. Before the application of the picture pulse, the appearance of the pixel 2 is e.g. white, denoted by W. The picture pulse of the pixel 2 is present from time t1 to time t2 and has e.g. a picture value of −15 Volts and an associated picture duration of 200 ms. As a result the appearance of the pixel 2 is black, denoted by B. The additional picture pulse is present from time t3 to time t4 and has e.g. an additional picture value of −1.5 Volts and an associated additional picture duration of 800 ms. The time interval between t2 and t3 is small, e.g. 10 ms, or even zero. As the additional picture pulse prevents the particles 6 from substantially changing their position, the appearance of the pixel 2 is substantially unchanged. This is also an example of the magnitude of the additional picture value being smaller than half the magnitude of the picture value, as well as an example of the additional picture energy being smaller than half the picture energy. If the time interval between t2 and t3 is substantially zero, this is also an example of the interval between the picture pulse and the additional picture pulse being substantially zero.

In another example each picture pulse has a picture value and an associated picture duration together representing a picture energy. Furthermore, each additional picture pulse has a predetermined number of sub-additional picture values and associated sub-additional picture durations representing sub-additional picture energies, whereby a time average of the sub-additional picture values has a sign equal to a sign of the picture value, and each sub-additional picture energy is smaller than the picture energy. In an example, the sequence of potential difference pulses of a pixel 2 out of said number is shown as a function of time in FIG. 4. Before the application of the picture pulse, the appearance of the pixel 2 is e.g. light gray, denoted by LG. The picture pulse of the pixel 2 is present from time t1 to time t2 and has e.g. a picture value of −15 Volts and an associated picture duration of 150 ms. As a result the appearance of the pixel 2 is black. The additional picture pulse is present from time t2 to time t4 and has e.g. two sub-additional picture values, subsequently present from time t2 to time t3 and from time t3 to time t4. The two sub-additional picture values are subsequently e.g. 1.5 Volts and −1.5 Volts and the associated sub-additional picture durations are e.g. 100 ms and 1000 ms, respectively. The time average of the sub-additional picture values is about −1.23 Volts, being (1.5*100−1.5*1000)/(100+1000) Volts. The application of the sub-additional picture values prevents the particles 6 from substantially changing their position and the appearance of the pixel 2 is substantially unchanged. In a variation of the embodiment each sub-additional picture value has a sign equal to the sign of the picture value. In an example, the sequence of potential difference pulses of a pixel 2 out of said number is shown as a function of time in FIG. 5. Before the application of the picture pulse, the appearance of the pixel 2 is e.g. middle gray, denoted by MG. The picture pulse of the pixel 2 is present from time t1 to time t2 and has e.g. a picture value of −15 Volts and an associated picture duration of 100 ms. As a result the appearance of the pixel 2 is black. The additional picture pulse is present from time t3 to time t8 and has e.g. three sub-additional picture values, subsequently present from time t3 to time t4, from time t5 to time t6 and from time t7 to time t8. Each sub-additional picture value has a sign equal to the sign of the picture value, e.g. the sub-additional picture values are −15 Volts and the associated sub-additional picture durations are e.g. 12 ms. The time intervals between the sub-additional picture values being −15 Volts, i.e. the time intervals from time t2 to time t3, from time t4 to time t5 and from time t6 to time t7 are e.g. each 200 ms. The application of the sub-additional picture values prevents the particles 6 from substantially changing their position and the appearance of the pixel 2 is substantially unchanged. This embodiment allows the use of simple driver IC's.

1. An electrophoretic display panel for displaying a picture comprising
a plurality of pixels, each pixel comprising two electrodes for receiving a potential difference and charged particles capable of occupying a number of different positions between the electrodes, and
drive means for supplying a sequence of potential difference pulses to each pixel, each sequence comprising, to display the picture, a picture pulse for bringing the particles into one of the positions,
characterized in that, with respect to at least a number of the pixels having received picture pulses for bringing their particles into extreme positions, the sequence of each pixel out of said number comprises an additional picture pulse subsequent to the picture pulse, which additional picture pulse serves to prevent the particles from substantially changing their position.

2. A display panel as claimed in claim 1 characterized in that
each picture pulse has a picture value and an associated picture duration together representing a picture energy,
each additional picture pulse has an additional picture value and an associated additional picture duration representing an additional picture energy,
the additional picture value has a sign equal to a sign of the picture value,
the additional picture value has a magnitude smaller than a magnitude of the picture value, and
the additional picture energy is smaller than the picture energy.

3. A display panel as claimed in claim 2 characterized in that the magnitude of each additional picture value is smaller than half the magnitude of the picture value.

4. A display panel as claimed in claim 3 characterized in that each additional picture energy is smaller than half the picture energy.

5. A display panel as claimed in claim 1 characterized in that each interval between the picture pulse and the additional picture pulse is substantially zero.

6. A display panel as claimed in claimed 1 characterized in that
each picture pulse has a picture value and an associated picture duration together representing a picture energy,
each additional picture pulse has a predetermined number of sub-additional picture values and associated sub-additional picture durations representing sub-additional picture energies,
a time average of the sub-additional picture values has a sign equal to a sign of the picture value, and
each sub-additional picture energy is smaller than the picture energy.

7. A display panel as claimed in claimed 6 characterized in that each sub-additional picture value has a sign equal to the sign of the picture value.

8. A display panel as claimed in claim 1 characterized in that said number of the pixels is equal to the total number of the pixels having received picture pulses for bringing their particles into extreme positions.

9. A display device comprising the display panel as claimed in claim 1.

10. A method for driving an electrophoretic display panel for displaying a picture, said display panel comprising a plurality of pixels, each pixel comprising two electrodes for receiving a potential difference and charged particles capable of occupying a number of different positions between the electrodes, said method comprising the step of supplying a sequence of potential difference pulses to each pixel, each sequence comprising, to display the picture, a picture pulse for bringing the particles into one of the positions, wherein, with respect to at least a number of the pixels having received picture pulses for bringing their particles into extreme positions, the sequence of each pixel out of said number comprises an additional picture pulse subsequent to the picture pulse, which additional picture pulse serves to prevent the particles from substantially changing their position.

11. Drive means for driving an electrophoretic display panel for displaying a picture, said display panel comprising a plurality of pixels, each pixel comprising two electrodes for receiving a potential difference and charged particles capable of occupying a number of different positions between the electrodes, said drive means being arranged to supply a sequence of potential difference pulses to each pixel, each sequence comprising, to display the picture, a picture pulse for bringing the particles into one of the positions, wherein, with respect to at least a number of the pixels having received picture pulses for bringing their particles into extreme positions, the sequence of each pixel out of said number comprises an additional picture pulse subsequent to the picture pulse, which additional picture pulse serves to prevent the particles from substantially changing their position.
